(19) United States
(12) Patent Application Publication
(10) Pub. No.: US 2010/0030966 A1
(43) Pub. Date: Feb. 4, 2010

(54) Cache memory and cache memory control apparatus

(75) Inventors: Taichi Hirao, Tokyo (JP); Naotaka Osawa, Kanagawa (JP); Koichi Hasegawa, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/458,053

(22) Filed: Jun. 30, 2009

(30) Foreign Application Priority Data
Jul. 31, 2008 (JP) 2008-197243

(51) Int. Cl. G06F 12/08; G06F 12/00

(52) U.S. Cl. 711/122; 711/118; 711/E12.017; 711/E12.024

(57) ABSTRACT

Disclosed herein is a cache memory including: a tag storage section including entries each including a tag address and a pending indication portion, at least one of the entries being to be referred to by a first address portion of an access address; a data storage section; a tag control section configured to compare a second address portion of the access address with the tag address included in each of the entries referred to to detect an entry whose tag address matches the second address portion, and, when the pending indication portion included in the detected entry indicates pending, cause an access related to the access address to be suspended; and a data control section configured to select data corresponding to the detected entry from among the data storage section, when the pending indication portion included in the detected entry does not indicate pending.

### BACKGROUND OF THE INVENTION

1. Field of the Invention

The present invention relates to a cache memory. In particular, the present invention relates to a cache memory capable of issuing a subsequent access without waiting for a response to a previous access to a memory, and a control apparatus for the same.

2. Description of the Related Art

A cache memory has often been used to reduce the frequency of access from a processor to a main memory. This method has been studied because an improvement in reducing a time taken to complete an access to the main memory is smaller than an improvement in increasing the speed of the processor. The main memory is relatively inexpensive but takes a relatively long time to complete the access, whereas the cache memory is relatively expensive but takes a relatively short time to complete the access. Reductions in both cost and time to complete the access can be achieved by implementing a hierarchical storage mechanism where the cache memory intervenes between the processor and the main memory.

In recent years, processor-containing systems including multiple processors have become increasingly prevalent. In many storage devices, the number of levels of the hierarchy of the aforementioned storage mechanism has increased so that a Level 2 cache and a Level 3 cache are used, and the Level 2 and Level 3 caches are shared by multiple processors.

When the processor accesses the cache memory, it is desirable that desired data exist in the cache memory, but the desired data sometimes does not exist in the cache memory, resulting in a cache miss. In this case, if this cache memory is closer to the processor by only one level than the main memory, an access from the cache memory to the main memory occurs.

In the case where this cache memory is shared by multiple processors, it is an important issue to allow a whole system to maintain efficient processing without interruption of operation, while the access to the main memory is in progress. For this purpose, the following techniques can be adopted:
(1) The processing is continued when a subsequent access to the cache memory has resulted in a cache hit (hit-under-miss); and
(2) In addition to the above technique (1), even when the subsequent access to the cache memory has resulted in a cache miss, the processing is continued (miss-under-miss).

At this time, if an address that is accessing the main memory is identical to an address to which the subsequent access has been made in the cache memory, it is necessary to take some measures to avoid data inconsistency, rather than simply unconditionally continue the process of the subsequent access. For this purpose, a queue may be provided for control to maintain storage coherence. For example, in a previously proposed multiple processor computing system where a hierarchical storage composed of an L1 cache, an L2 cache, and an L3 memory is assumed, an L1 storage queue and an L2 storage queue are provided in order to maintain the storage coherence (see Japanese Patent Laid-Open No. Hei 01-246655 (FIG. 1), for example).

### SUMMARY OF THE INVENTION

However, the above method of providing the queues to maintain the storage coherence involves the need of a comparison circuit for an address accessing to the main memory and so on, resulting in increased circuit scale and more complicated control. Moreover, when the aforementioned miss-under-miss is to be accomplished, a maximum number of subsequent cache misses that can be permitted at a time is limited to the number of records in the queue.

The present invention addresses the above-identified, and other problems associated with existing methods and apparatuses, and makes it possible to use a simple structure in the cache memory and allow a subsequent access to be issued without the need to wait for a response to a previous access to the memory.

According to an embodiment of the present invention, there is provided a cache memory including: a tag storage section including a plurality of entries each including a tag address and a pending indication portion, at least one of the entries being to be referred to by a first address portion of an access address; a data storage section configured to store data corresponding to each of the entries; a tag control section configured to compare a second address portion, different from the first address portion, of the access address with the tag address included in each of the at least one of the entries referred to to detect an entry whose tag address matches the second address portion, and, when the pending indication portion included in the detected entry indicates pending, cause an access related to the access address to be suspended; and a data control section configured to select data corresponding to the detected entry from among the data storage section, when the pending indication portion included in the detected entry does not indicate pending. This allows an access to be suspended when the pending indication portion of an entry concerning this access indicates pending, and otherwise permit the access.

According to another embodiment of the present invention, there is provided a cache memory control apparatus including: a tag storage section including a plurality of entries each including a tag address and a pending indication portion, at least one of the entries being to be referred to by a first address portion of an access address; and a tag control section configured to compare a second address portion, different from the first address portion, of the access address with the tag address included in each of the at least one of the entries referred to to detect an entry whose tag address matches the second address portion, and, when the pending indication portion included in the detected entry indicates pending, cause an access related to the access address to be suspended. This allows an access to be suspended when the pending indication portion of an entry concerning this access indicates pending.

The present invention produces an excellent effect of making it possible to use a simple structure in a cache memory and allow a subsequent access to be issued without the need to wait for a response to a previous access to a memory.

### BRIEF DESCRIPTION OF THE DRAWINGS

FIG. 1 is a diagram illustrating an exemplary structure of an information processing system according to an embodiment of the present invention;

FIG. 2 is a diagram illustrating an exemplary functional structure of a Level 2 cache according to an embodiment of the present invention;

FIG. 3 is a diagram illustrating an exemplary circuit structure of the Level 2 cache according to an embodiment of the present invention;

FIG. 4 is a diagram illustrating exemplary correspondences between a data storage section and a main memory according to an embodiment of the present invention;

FIG. 5 is a diagram illustrating an exemplary structure of a tag storage section according to an embodiment of the present invention;

FIG. 6 is a diagram illustrating exemplary operations performed by the Level 2 cache according to an embodiment of the present invention, in response to a read instruction;

FIG. 7 is a diagram illustrating exemplary operations performed by the Level 2 cache according to an embodiment of the present invention, in response to a write instruction;

FIG. 8 is a diagram illustrating exemplary operations performed by the Level 2 cache according to an embodiment of the present invention, in response to a fill instruction;

FIG. 9 is a diagram illustrating exemplary operations performed by the Level 2 cache according to an embodiment of the present invention, in response to a refill instruction;

FIG. 10 is a diagram illustrating exemplary operations performed by the Level 2 cache according to an embodiment of the present invention, in response to a zero allocation instruction;

FIG. 11 is a diagram illustrating exemplary operations performed by the Level 2 cache according to an embodiment of the present invention, in response to a hit/write-back/invalidation instruction;

FIG. 12 is a diagram illustrating exemplary operations performed by the Level 2 cache according to an embodiment of the present invention, in response to a hit/write-back instruction;

FIG. 13 is a diagram illustrating exemplary operations performed by the Level 2 cache according to an embodiment of the present invention, in response to a hit/invalidation instruction;

FIG. 14 is a diagram illustrating exemplary operations performed by the Level 2 cache according to an embodiment of the present invention, in response to an index/write-back/invalidation instruction;

FIG. 15 is a diagram illustrating exemplary operations performed by the Level 2 cache according to an embodiment of the present invention, in response to an index/write-back instruction;

FIG. 16 is a diagram illustrating exemplary operations performed by the Level 2 cache according to an embodiment of the present invention, in response to an index/invalidation instruction;

FIG. 17 is a timing diagram illustrating exemplary operations performed when the read instructions are issued, according to an embodiment of the present invention;

FIG. 18 is a timing diagram illustrating other exemplary operations performed when the read instructions are issued, according to an embodiment of the present invention; and

FIG. 19 is a timing diagram illustrating still other exemplary operations performed when the read instructions are issued, according to an embodiment of the present invention.

### DETAILED DESCRIPTION OF THE PREFERRED EMBODIMENTS

Hereinafter, preferred embodiments of the present invention will be described in detail with reference to the accompanying drawings.

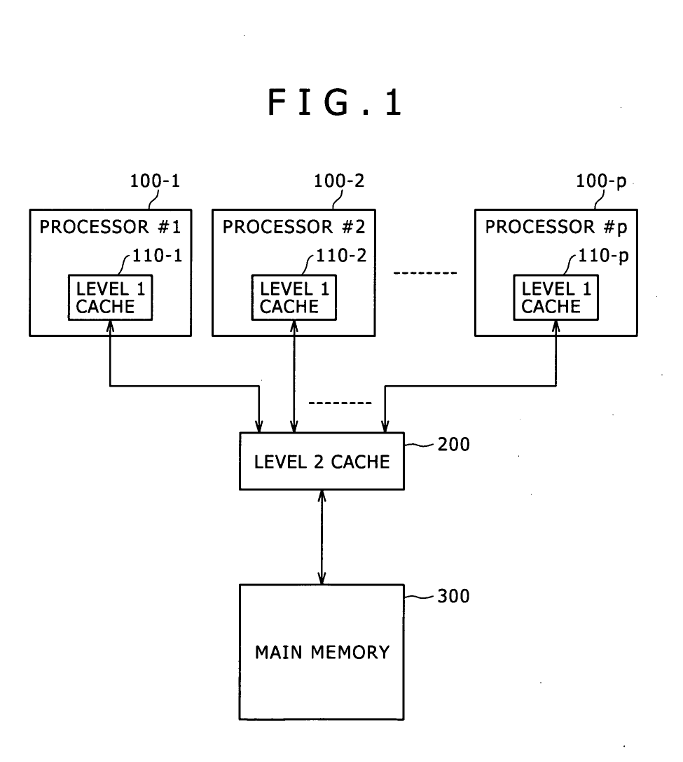

FIG. 1 is a diagram illustrating an exemplary structure of an information processing system according to an embodiment of the present invention. This information processing system includes p processors 100-1 to 100-p (where p is an integer greater than 1) (hereinafter referred to collectively as a “processor 100” as appropriate), a Level 2 cache 200, and a main memory 300.

The processor 100 contains a corresponding one of Level 1 caches 110-1 to 110-p (hereinafter referred to collectively as an “Level 1 cache 110” as appropriate). As such, the processor 100 performs a data access using the Level 1 cache 110 as long as a hit occurs in the Level 1 cache 110, but when a miss hit has occurred in the Level 1 cache 110, an access is made to the Level 2 cache 200. Moreover, when a miss hit has occurred in the Level 1 cache 110, the processor 100 performs a data access using the Level 2 cache 200 as long as a hit occurs in the Level 2 cache 200. Meanwhile, if a miss hit occurs in the Level 2 cache 200, an access is made to the main memory 300.

As described above, this embodiment of the present invention adopts a three-level storage structure made up of the Level 1 cache 110 in each processor 100, the common Level 2 cache 200, and the main memory 300.

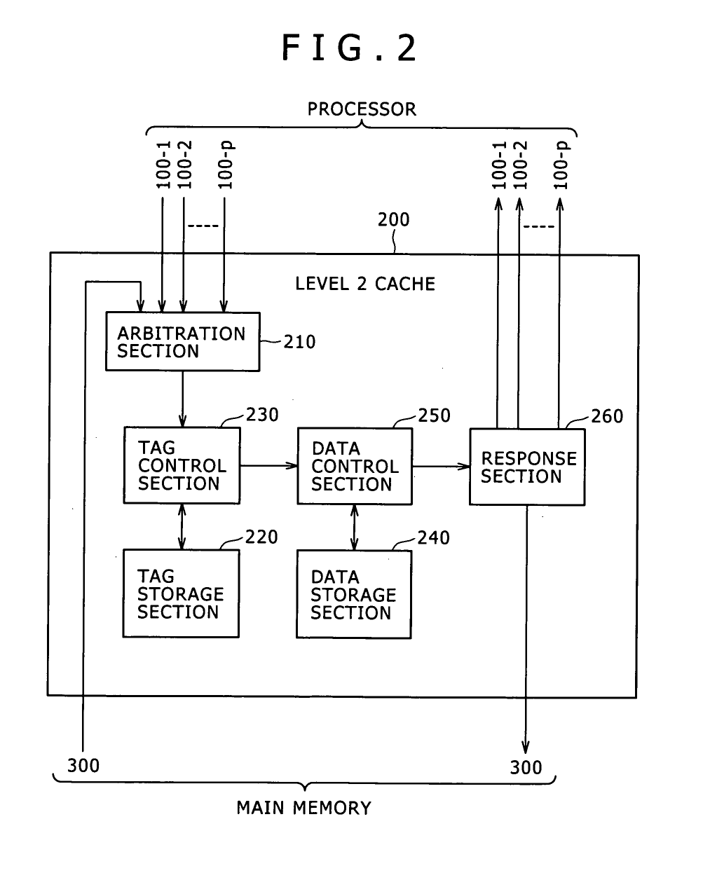

FIG. 2 is a diagram illustrating an exemplary functional structure of the Level 2 cache 200 according to this embodiment of the present invention. The Level 2 cache 200 includes an arbitration section 210, a tag storage section 220, a tag control section 230, a data storage section 240, a data control section 250, and a response section 260.

The arbitration section 210 arbitrates accesses from the processors 100-1 to 100-p and the main memory 300 to grant access permission to one of them. The arbitration by the arbitration section 210 is, for example, accomplished by round-robin scheduling, in which the access permission is granted to the processors 100-1 to 100-p and the main memory 300 sequentially. The accesses permitted are supplied to the tag control section 230.

The tag storage section 220 is a memory including a plurality of entries, and holds a tag address and so on in each entry. The tag address represents a part of an accessed address, as described below. Each entry in the tag storage section 220 is referred to by another part of the accessed address. Note that the tag storage section 220 is an example of a tag storage section as recited in the appended claims.

The tag control section 230 exercises control by selecting one of the entries to be accessed in the tag storage section 220, based on the accessed address. The entry selected by the tag control section 230 is notified to the data control section 250.

The data storage section 240 stores data corresponding to each entry in the tag storage section 220. The data stored in the data storage section 240 is managed on a cache line basis, and transfer of the data in relation to the main memory 300 and the processor 100 is carried out on a cache line basis as well. Note that the data storage section 240 is an example of a data storage section as recited in the appended claims.

The data control section 250 accesses the data (cache line) stored in the data storage section 240 in accordance with the entry selected in the tag control section 230. In the case of a read access or write-back operation, the data read from the data storage section 240 is supplied to the response section 260. In the case of a write access, write data is embedded at a relevant location in the data read from the data storage section 240, and the resulting data is stored back into the data storage section 240.

The response section 260 outputs the data supplied from the data control section 250 to one of the processors 100-1 to 100-p or the main memory 300. In the case of a response to a read access from the processor 100, the data is outputted to the accessing processor 100. In the case of a write-back operation in relation to the main memory 300, the data is outputted to the main memory 300.

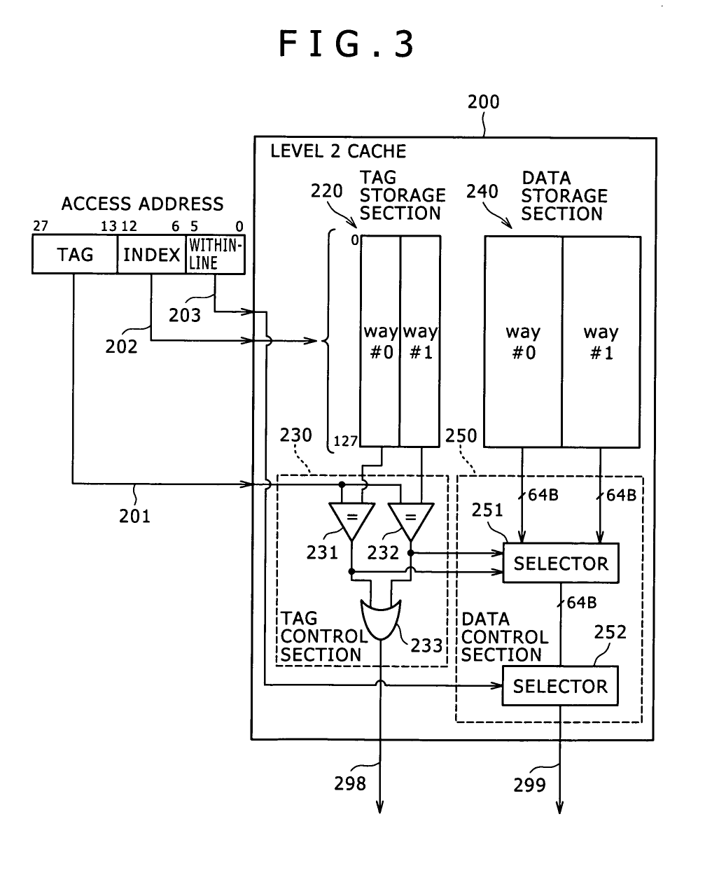

FIG. 3 is a diagram illustrating an exemplary circuit structure of the Level 2 cache 200 according to this embodiment of the present invention. It is assumed here that the Level 2 cache 200 is a 2-way set associative cache with 128 lines and a line size of 64 B (bytes). In other words, storage of a maximum of two cache lines is possible for the same index address, and the size of data corresponding to each cache line is 64 B.

Assuming that the size of the main memory 300 is 256 MB, the required size of the address is 28 bits. Since the block size is 64 B, a total of 6 bits, bits 0 to 5, of an access address are allocated to a within-line address. Further, since the number of lines is 128, the index address used to refer to an entry in the tag storage section 220 is allocated to a total of 7 bits, bits 6 to 12, of the access address. Consequently, the tag address is allocated to a total of 15 bits, bits 13 to 27, of the access address. The tag address, the index address, and the within-line address in the access address are supplied to the Level 2 cache 200 via a signal line 201, a signal line 202, and a signal line 203, respectively.

The tag storage section 220 includes two ways #0 and #1, each including 128 entries. Each way of the tag storage section 220 is referred to by the index address supplied via the signal line 202. Therefore, in this embodiment, two entries are referred to. Note that the tag storage section 220 is an example of a tag storage section as recited in the appended claims.

The tag control section 230 includes comparators 231 and 232 and an OR operator 233. The tag control section 230 detects that one of the entries referred to in the tag storage section 220 whose tag address matches the tag address supplied via the signal line 201. The comparator 231 compares the tag address included in the entry referred to in way #0 of the tag storage section 220 with the tag address supplied via the signal line 201 to detect whether they match each other. Similarly, the comparator 232 compares the tag address included in the entry referred to in way #1 of the tag storage section 220 with the tag address supplied via the signal line 201 to detect whether they match each other. Results of the comparison by the comparators 231 and 232 are supplied to the OR operator 233 and the data control section 250. If a matching is detected in either of the comparators 231 and 232, the OR operators 233 outputs a notification of occurrence of a hit via a signal line 298. Note, however, that in the case where a valid bit of the relevant entry indicates invalidity, it is determined that a miss hit has occurred, as described below.

The data storage section 240 includes two ways #0 and #1, each of which is composed of 128 cache lines. The data storage section 240 stores the data corresponding to each entry in the tag storage section 220. The data storage section 240 is also referred to by the index address supplied via the signal line 202, as with the tag storage section 220. As a result, two pieces of 64 B line data are supplied to the data control section 250.

The data control section 250 includes selectors 251 and 252. The selector 251 selects one of the two pieces of 64 B data supplied from the data storage section 240. Specifically, when a matching has been detected in the comparator 231, the line data from way #0 of the data storage section 240 is selected, whereas when a matching has been detected in the comparator 232, the line data from way #1 of the data storage section 240 is selected. Note, however, that in the case where the valid bit of the entry for which the matching has been detected indicates invalidity, the data in the corresponding cache line is not selected, as described below. In the case where a matching has been detected in neither of the comparators 231 and 232, the data in neither of the cache lines is selected. Note that the data control section 250 is an example of a data control section as recited in the appended claims.

The selector 252 selects data at a location specified by the within-line address in the selected line data. The within-line address is supplied via the signal line 203. Note that this function of the selector 252 may be implemented in the processor 100, alternatively. In either case, the whole or a part of the line data is outputted to the response section 260 via a signal line 299.

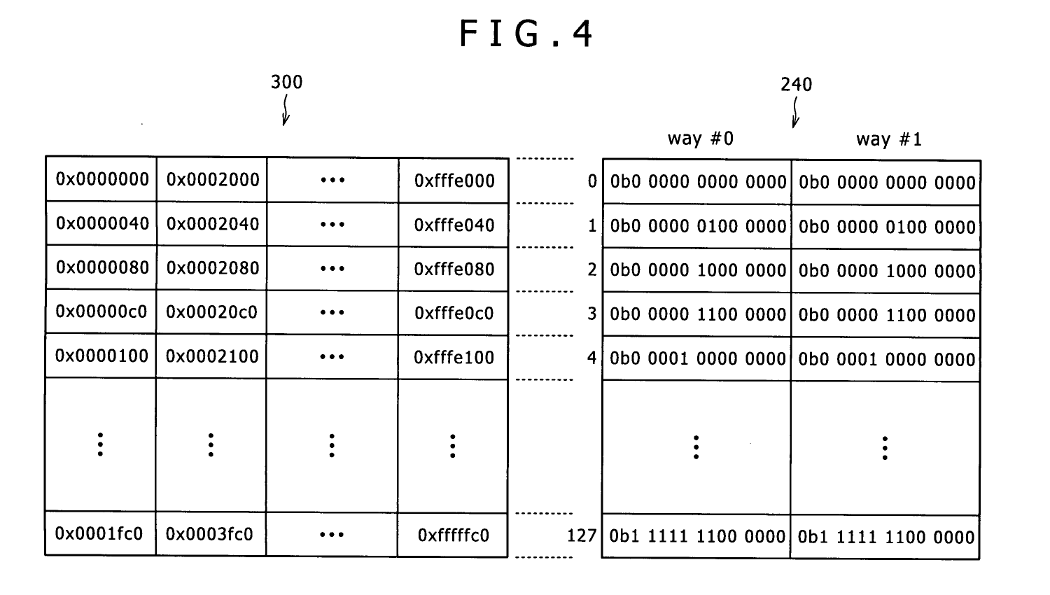

FIG. 4 is a diagram illustrating exemplary correspondences between the data storage section 240 and the main memory 300 according to this embodiment of the present invention. Here, as in the example of FIG. 3, it is assumed that the Level 2 cache 200 is a 2-way set associative cache with 128 lines and a block size of 64 B.

Each cache line in the data storage section 240 is referred to by the index address as described above. The index address of a 0th line is “0,” the index address of a 1st line is “1,” and so on, until the index address of a 127th line is “127.”

In the 0th line in the data storage section 240, a line for which the lowest-order 13 bits of the address is “0b0000000000000” (hereinafter, “0b” indicates that a number that follows it is in binary) is stored. In the 1st line in the data storage section 240, a line for which the lowest-order 13 bits of the address is “0b0000001000000” is stored. In a 2nd line in the data storage section 240, a line for which the lowest-order 13 bits of the address is “0b0000010000000” is stored. In a 3rd line in the data storage section 240, a line for which the lowest-order 13 bits is “0b0000011000000” is stored. In a 4th line in the data storage section 240, a line for which the lowest-order 13 bits of the address is “0b0000100000000” is stored, and so on. Finally, in the 127th line in the data storage section 240, a line for which the lowest-order 13 bits of the address is “0b1111111000000” is stored.

That is, according to this embodiment, for a given index address, only two cache lines are capable of storage in the Level 2 cache 200. Accordingly, in the case where new data is to be stored in a set of two cache lines that have already been occupied, it is necessary to evict and replace one of the cache lines. One known method for selecting the cache line to be replaced is LRU (Least Recently Used) policy, which evicts the least recently used cache line. The replacement method according to this embodiment of the present invention is also based on the LRU policy, but is modified in its details as described below.

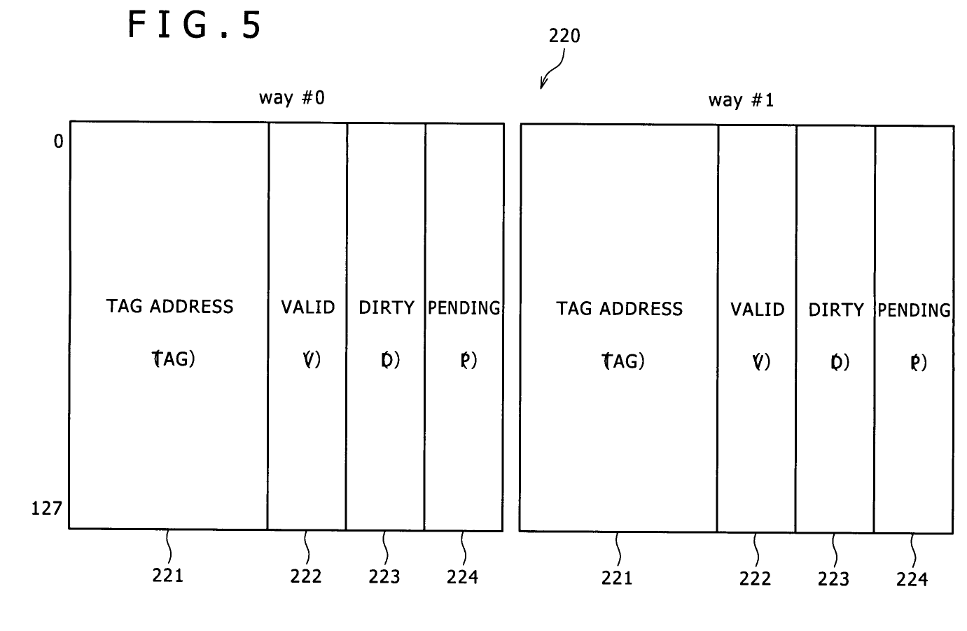

FIG. 5 is a diagram illustrating an exemplary structure of the tag storage section 220 according to this embodiment of the present invention. Each entry in the tag storage section 220 includes a tag address field 221, a valid field 222, a dirty field 223, and a pending field 224.

The tag address field 221 stores the tag address (i.e., the highest-order 15 bits of the address) of the cache line corresponding to the relevant entry. In the figure, the tag address field 221 is labeled “TAG” for short.

The valid field 222 stores the valid bit, which indicates whether the relevant entry is valid. If the valid field 222 represents “1,” that means that the data in the cache line corresponding to the relevant entry is valid. When the valid field 222 represents “0,” even if a matching is detected in the comparator 231 or 232, it is not determined that a hit has occurred. In the figure, the valid field 222 is labeled “V” for short.

The dirty field 223 stores a dirty bit, which indicates whether the data in the cache line corresponding to the relevant entry and corresponding data in the main memory 300 are identical to each other. If the dirty field 223 represents “1,” that means that the data in the cache line corresponding to the relevant entry and the corresponding data in the main memory 300 are not identical to each other, and that the data in the Level 2 cache 200 is fresh. On the other hand, if the dirty field 223 represents “0,” that means that the data in the cache line corresponding to the relevant entry and corresponding data in the main memory 300 are identical to each other. In the figure, the dirty field 223 is labeled “D” for short.

The pending field 224 stores a pending bit, which indicates whether the cache line corresponding to the relevant entry is currently waiting for data from the main memory 300. If the pending field 224 represents “1,” that means that the cache line corresponding to the relevant entry is waiting for data from the main memory 300. Meanwhile, if the pending field 224 represents “0,” that means that data is not expected to be transferred from the main memory 300 to the cache line corresponding to the relevant entry. In the figure, the pending field 224 is labeled “P” for short.

Next, operations according to this embodiment of the present invention will now be described below with reference to the accompanying drawings. In this embodiment of the present invention, it is assumed that when V=0, D=0 and P=0 always hold, and that when V=1, D=1 and P=1 never hold at the same time. Impossible cases are labeled “(Unused)” in figures that follow.

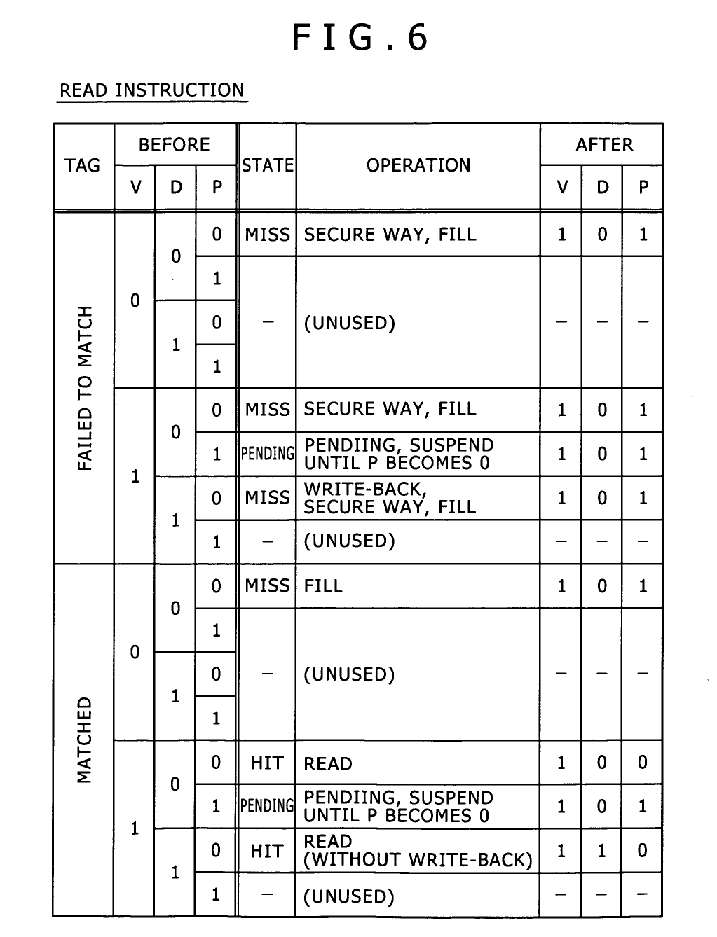

FIG. 6 is a diagram illustrating exemplary operations performed by the Level 2 cache 200 according to this embodiment of the present invention, in response to a read instruction. The read instruction is an instruction to read data from the main memory 300. Note that in the case where a hit occurs in the Level 2 cache 200, the data can be read from the Level 2 cache 200, without the need to access the main memory 300.

Suppose that either of the comparators 231 and 232 has detected a matching of the tag addresses with respect to a given entry. In this case, if V=1, then a hit determination is made basically, and the data is read from the relevant cache line. At this time, even if D=1, the data in the cache line is not written back to the main memory 300. No change is made to the status of V, D, and P.

However, even when a matching of the tag addresses is detected and V=1, if P=1, a pending state results. That is, in this case, since the relevant cache line is waiting for data from the main memory 300, this cache line cannot be read at the moment. Accordingly, the read is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically. Accordingly, in the case where a matching of the tag addresses is not detected, the way to be replaced is determined in accordance with the LRU policy or the like, and the relevant cache line is filled with data from the main memory 300. At this time, if D=1, then the data in the relevant cache line is written back to the main memory 300 prior to the replacement. Note that even when a matching of the tag addresses is detected, if V=0, there is no need to determine the way anew, and therefore the relevant cache line may be filled with the data from the main memory 300. In these cases, the status of P shifts to P=1 when an instruction for the fill operation has been issued to the main memory 300. Therefore, in these cases, the status of V, D, and P will be V=1, D=0, and P=1 immediately after the operation.

However, when a matching of the tag addresses is not detected and P=1, the pending state results. That is, in this case, since the relevant cache line is waiting for data from the main memory 300, this cache line cannot be replaced at the moment. Accordingly, the replacement is suspended until P=0 comes to hold. During this time, accesses to the Level 2 cache 200 based on other instructions are accepted.

In this embodiment of the present invention, the way to be replaced is determined in accordance with the LRU policy or the like as in related art. In other embodiments of the present invention, however, precedence may be given to the cache line for which P=0, while the cache line for which P=1 is excluded. In this case, if P=1 in cache lines in all ways, one of the cache lines is chosen. In this case, the replacement is suspended until P=0 comes to hold, as described above.

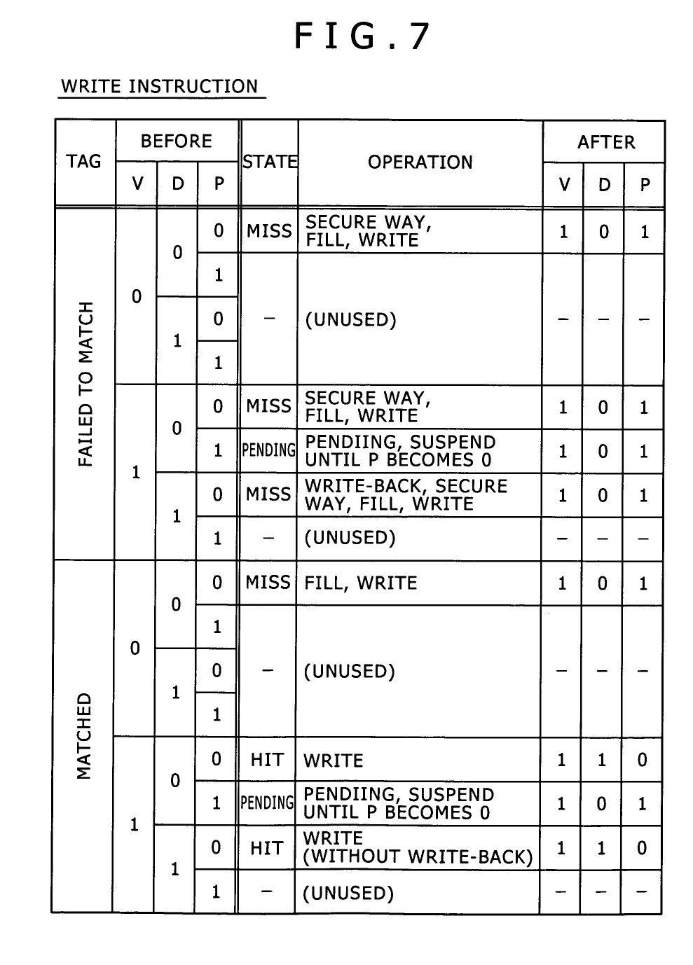

FIG. 7 is a diagram illustrating exemplary operations performed by the Level 2 cache 200 according to this embodiment of the present invention, in response to a write instruction. The write instruction is an instruction to write data to the main memory 300. Note that in the case where a hit occurs in the Level 2 cache 200, the data can be written to the Level 2 cache 200, without the need to access the main memory 300.

Suppose that either of the comparators 231 and 232 has detected a matching of the tag addresses with respect to a given entry. In this case, if V=1, then a hit determination is made basically, and the data is written to the relevant cache line. At this time, even if D=1, the data in the cache line is not written back to the main memory 300.

However, even when a matching of the tag addresses is detected and V=1, if P=1, the pending state results. That is, in this case, since the relevant cache line is waiting for data from the main memory 300, the data cannot be written to this cache line at the moment. Accordingly, the write is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically. Accordingly, in the case where a matching of the tag addresses is not detected, the way to be replaced is determined in accordance with the LRU policy or the like, and after the relevant cache line is filled with data from the main memory 300, the write is performed. At this time, if D=1, then the data in the relevant cache line is written back to the main memory 300 prior to the replacement. Note that even when a matching of the tag addresses is detected, if V=0, there is no need to determine the way anew, and therefore the relevant cache line may be filled with the data from the main memory 300. In these cases, the status of P shifts to P=1 when an instruction for the fill operation has been issued to the main memory 300. Therefore, in these cases, the status of V, D, and P will be V=1, D=0, and P=1 immediately after the operation.

However, when a matching of the tag addresses is not detected and P=1, the pending state results. That is, in this case, since the relevant cache line is waiting for data from the main memory 300, this cache line cannot be replaced at the moment. Accordingly, the replacement is suspended until P=0 comes to hold. During this time, accesses to the Level 2 cache 200 based on other instructions are accepted.

In this embodiment of the present invention, the way to be replaced is determined in accordance with the LRU policy or the like as in related art. In other embodiments of the present invention, however, precedence may be given to the cache line for which P=0, while the cache line for which P=1 is excluded. In this case, if P=1 in cache lines in all ways, one of the cache lines is chosen. In this case, the replacement is suspended until P=0 comes to hold, as described above.

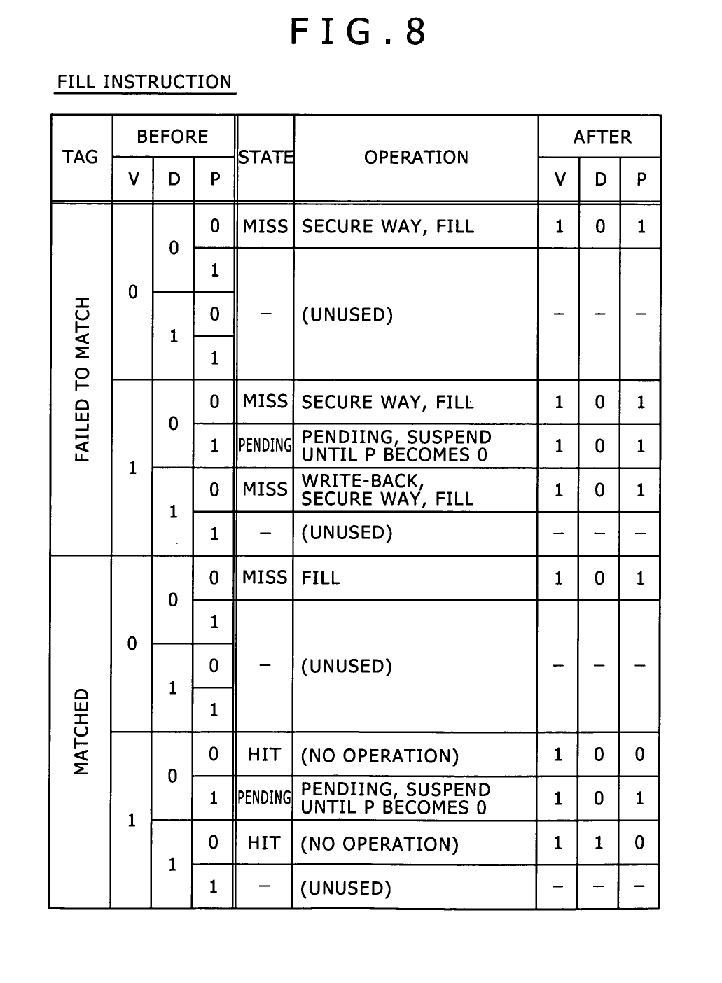

FIG. 8 is a diagram illustrating exemplary operations performed by the Level 2 cache 200 according to this embodiment of the present invention, in response to a fill instruction. The fill instruction is an instruction to allocate a cache line in the Level 2 cache 200 from the main memory 300. Note that in the case where a hit occurs in the Level 2 cache 200, the relevant cache line can be used as it is, and therefore no operation is performed.

Suppose that either of the comparators 231 and 232 has detected a matching of the tag addresses with respect to a given entry. In this case, if V=1, then a hit determination is made basically, and no operation is performed.

However, even when a matching of the tag addresses is detected and V=1, if P=1, the pending state results. That is, in this case, since the relevant cache line is waiting for data from the main memory 300, this cache line cannot be used at the moment. Accordingly, completion of the fill instruction is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically. Accordingly, in the case where a matching of the tag addresses is not detected, the way to be replaced is determined in accordance with the LRU policy or the like, and the relevant cache line is filled with data from the main memory 300. At this time, if D=1, then the data in the relevant cache line is written back to the main memory 300 prior to the replacement. Note that even when a matching of the tag addresses is detected, if V=0, there is no need to determine the way anew, and therefore the relevant cache line may be filled with the data from the main memory 300. In these cases, the status of P shifts to P=1 when an instruction for the fill operation has been issued to the main memory 300. Therefore, in these cases, the status of V, D, and P will be V=1, D=0, and P=1 immediately after the operation.

However, when a matching of the tag addresses is not detected and P=1, the pending state results. That is, in this case, since the relevant cache line is waiting for data from the main memory 300, this cache line cannot be replaced at the moment. Accordingly, the replacement is suspended until P=0 comes to hold. During this time, accesses to the Level 2 cache 200 based on other instructions are accepted.

In this embodiment of the present invention, the way to be replaced is determined in accordance with the LRU policy or the like as in related art. In other embodiments of the present invention, however, precedence may be given to the cache line for which P=0, while the cache line for which P=1 is excluded. In this case, if P=1 in cache lines in all ways, one of the cache lines is chosen. In this case, the replacement is suspended until P=0 comes to hold, as described above.

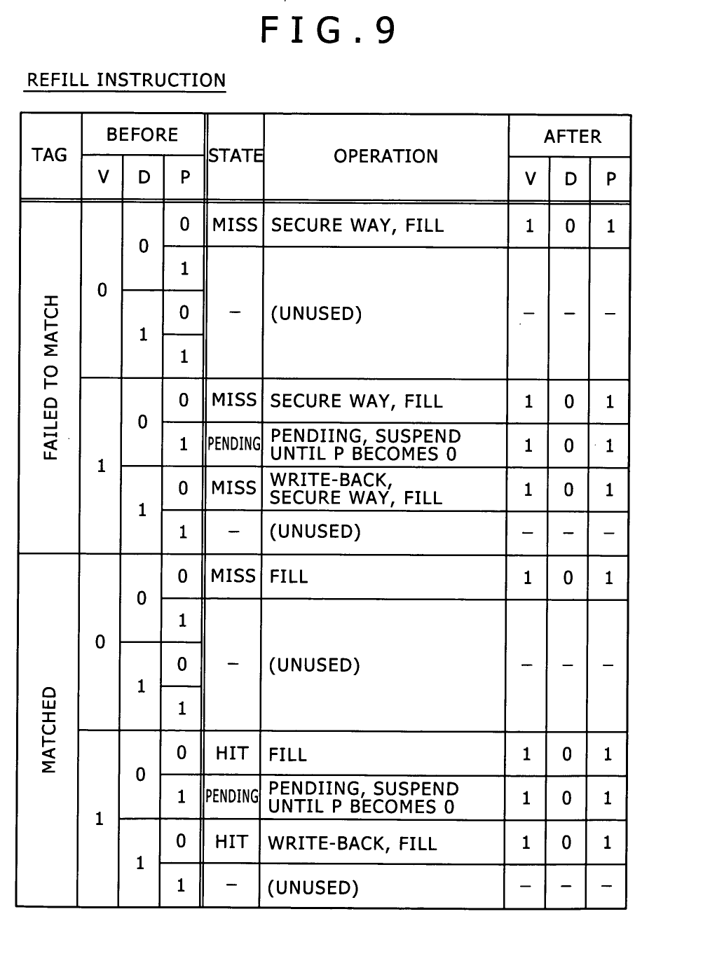

FIG. 9 is a diagram illustrating exemplary operations performed by the Level 2 cache 200 according to this embodiment of the present invention, in response to a refill instruction. The refill instruction is an instruction to allocate a cache line in the Level 2 cache 200 anew from the main memory 300, regardless of whether a hit or a miss hit occurs.

Suppose that either of the comparators 231 and 232 has detected a matching of the tag addresses with respect to a given entry. In this case, if V=1, then a hit determination is made basically, and the relevant cache line is filled anew. At this time, if D=1, the data in the cache line is written back to the main memory 300. Therefore, in these cases, the status of V, D, and P will be V=1, D=0, and P=1 immediately after the operation.

However, even when a matching of the tag addresses is detected and V=1, if P=1, the pending state results. That is, in this case, since the relevant cache line is waiting for data from the main memory 300, this cache line cannot be used at the moment. Accordingly, completion of the refill instruction is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically. Accordingly, in the case where a matching of the tag addresses is not detected, the way to be replaced is determined in accordance with the LRU policy or the like, and the relevant cache line is filled with data from the main memory 300. At this time, if D=1, then the data in the relevant cache line is written back to the main memory 300 prior to the replacement. Note that even when a matching of the tag addresses is detected, if V=0, there is no need to determine the way anew, and therefore the relevant cache line may be filled with the data from the main memory 300. In these cases, the status of P shifts to P=1 when an instruction for the fill operation has been issued to the main memory 300. Therefore, in these cases, the status of V, D, and P will be V=1, D=0, and P=1 immediately after the operation.

However, when a matching of the tag addresses is not detected and P=1, the pending state results. That is, in this case, since the relevant cache line is waiting for data from the main memory 300, this cache line cannot be replaced at the moment. Accordingly, the replacement is suspended until P=0 comes to hold. During this time, accesses to the Level 2 cache 200 based on other instructions are accepted.

In this embodiment of the present invention, the way to be replaced is determined in accordance with the LRU policy or the like as in related art. In other embodiments of the present invention, however, precedence may be given to the cache line for which P=0, while the cache line for which P=1 is excluded. In this case, if P=1 in cache lines in all ways, one of the cache lines is chosen. In this case, the replacement is suspended until P=0 comes to hold, as described above.

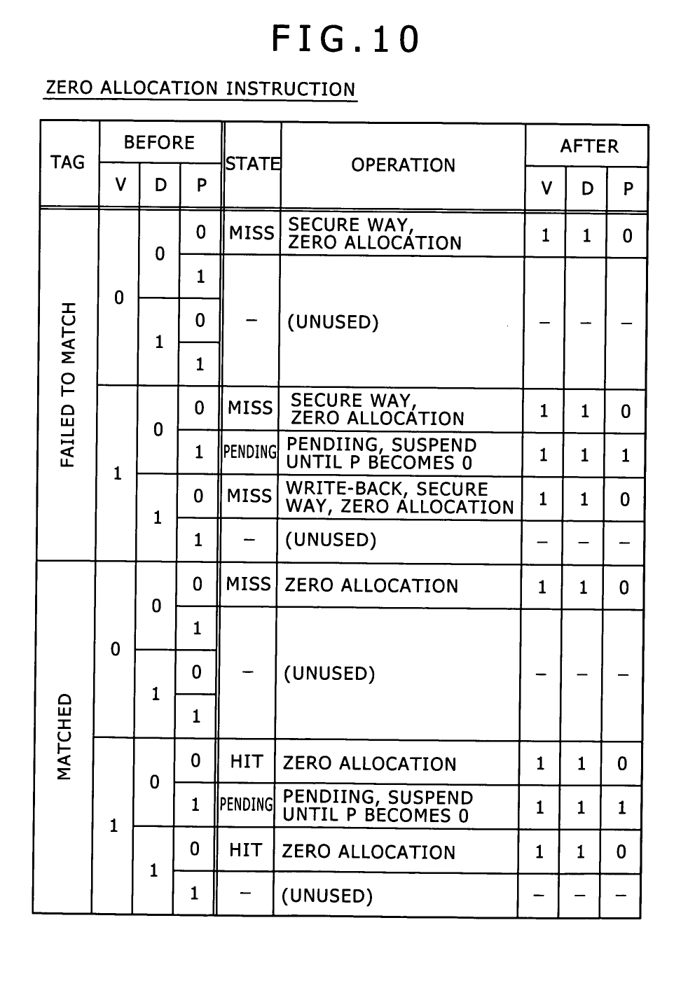

FIG. 10 is a diagram illustrating exemplary operations performed by the Level 2 cache 200 according to this embodiment of the present invention, in response to a zero allocation instruction. The zero allocation instruction is an instruction to write a zero value to a cache line in the Level 2 cache 200. After execution of this instruction, the status of V and D will be V=1 and D=1.

Suppose that either of the comparators 231 and 232 has detected a matching of the tag addresses with respect to a given entry. In this case, if V=1, then a hit determination is made basically, and the zero value is written to the relevant cache line. At this time, even if D=1, the data in the cache line is not written back to the main memory 300.

However, even when a matching of the tag addresses is detected and V=1, if P=1, the pending state results. That is, in this case, since the relevant cache line is waiting for data from the main memory 300, the zero value cannot be written to this cache line at the moment. Accordingly, the writing of the zero value is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically. Accordingly, in the case where a matching of the tag addresses is not detected, the way to be replaced is determined in accordance with the LRU policy or the like, and after the relevant cache line is filled with data from the main memory 300, the write is performed. At this time, if D=1, then the data in the relevant cache line is written back to the main memory 300 prior to the replacement. Note that even when a matching of the tag addresses is detected, if V=0, there is no need to determine the way anew, and therefore the relevant cache line may be filled with the data from the main memory 300. In these cases, the status of P shifts to P=1 when the instruction for the fill operation has been issued to the main memory 300.

However, when a matching of the tag addresses is not detected and P=1, the pending state results. That is, in this case, since the relevant cache line is waiting for data from the main memory 300, this cache line cannot be replaced at the moment. Accordingly, the replacement is suspended until P=0 comes to hold. During this time, accesses to the Level 2 cache 200 based on other instructions are accepted.

In this embodiment of the present invention, the way to be replaced is determined in accordance with the LRU policy or the like as in related art. In other embodiments of the present invention, however, precedence may be given to the cache line for which P=0, while the cache line for which P=1 is excluded. In this case, if P=1 in cache lines in all ways, one of the cache lines is chosen. In this case, the replacement is suspended until P=0 comes to hold, as described above.

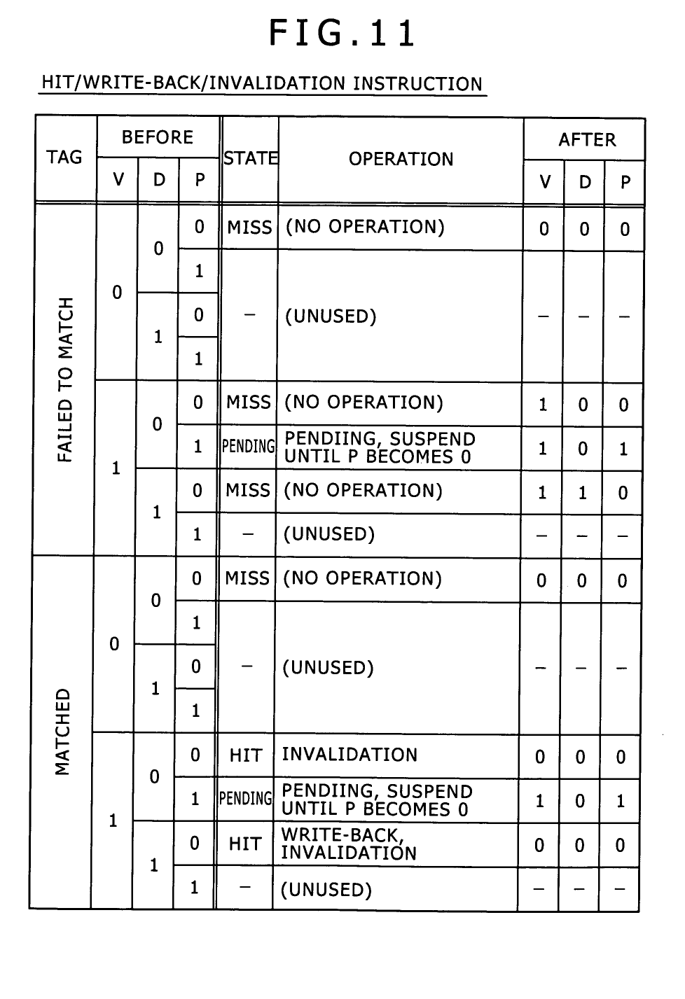

FIG. 11 is a diagram illustrating exemplary operations performed by the Level 2 cache 200 according to this embodiment of the present invention, in response to a hit/write-back/invalidation instruction. The hit/write-back/invalidation instruction is an instruction to, when a hit occurs in the Level 2 cache 200 and D=1, write the data in the relevant cache line back to the main memory 300 and invalidate this cache line. Note, however, that when a miss hit occurs in the Level 2 cache 200, no operation is performed.

Suppose that either of the comparators 231 and 232 has detected a matching of the tag addresses with respect to a given entry. In this case, if V=1, then a hit determination is made basically, and the relevant cache line is invalidated. At this time, if D=1, the data in the cache line is written back to the main memory 300 prior to the invalidation of the cache line.

However, even when a matching of the tag addresses is detected and V=1, if P=1, the pending state results. That is, in this case, since the relevant cache line is waiting for data from the main memory 300, this cache line cannot be invalidated at the moment. Accordingly, the invalidation is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically, and no operation is performed.

However, when a matching of the tag addresses is not detected and P=1, the pending state results. That is, in this case, since the relevant cache line is waiting for data from the main memory 300, this cache line cannot be used at the moment. Accordingly, completion of the hit/write-back/invalidation instruction is suspended until P=0 comes to hold. During this time, accesses to the Level 2 cache 200 based on other instructions are accepted.

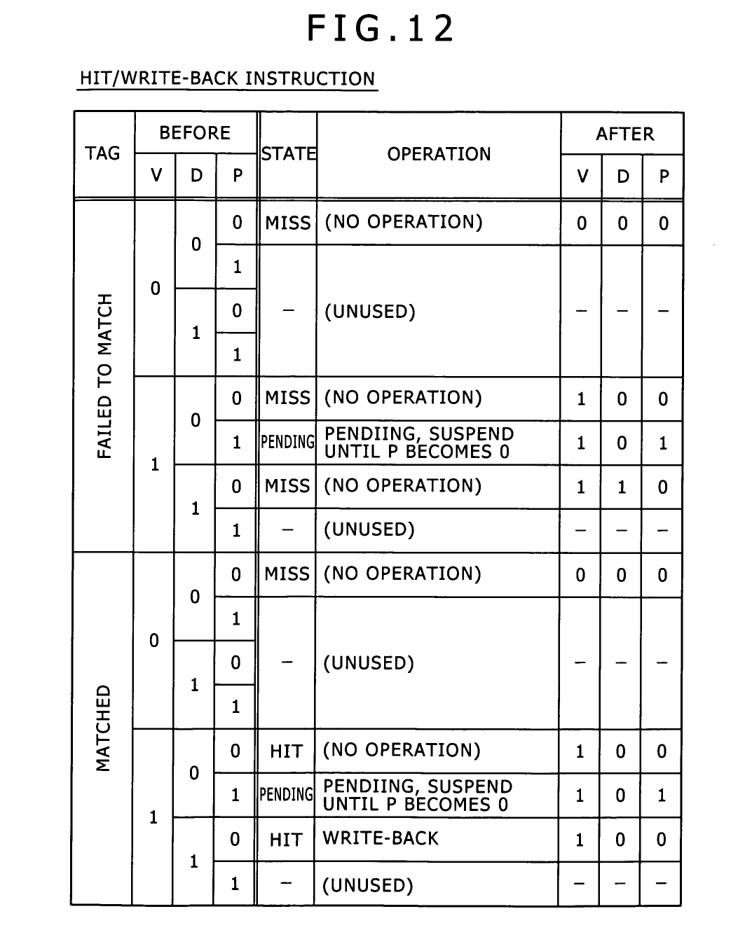

FIG. 12 is a diagram illustrating exemplary operations performed by the Level 2 cache 200 according to this embodiment of the present invention, in response to a hit/write-back instruction. The hit/write-back instruction is an instruction to, when a hit occurs in the Level 2 cache 200 and D=1, write the data in the relevant cache line back to the main memory 300. Note, however, that when a miss hit occurs in the Level 2 cache 200, no operation is performed.

Suppose that either of the comparators 231 and 232 has detected a matching of the tag addresses with respect to a given entry. In this case, if V=1, then a hit determination is made basically. At this time, if D=1, then the data in the cache line is written back to the main memory 300. If D=0, then no operation is performed.

However, even when a matching of the tag addresses is detected and V=1, if P=1, the pending state results. That is, in this case, since the relevant cache line is waiting for data from the main memory 300, this cache line cannot be used at the moment. Accordingly, completion of the hit/write-back instruction is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically, and no operation is performed.

However, when a matching of the tag addresses is not detected and P=1, the pending state results. That is, in this case, since the relevant cache line is waiting for data from the main memory 300, this cache line cannot be used at the moment. Accordingly, the completion of the hit/write-back instruction is suspended until P=0 comes to hold. During this time, accesses to the Level 2 cache 200 based on other instructions are accepted.

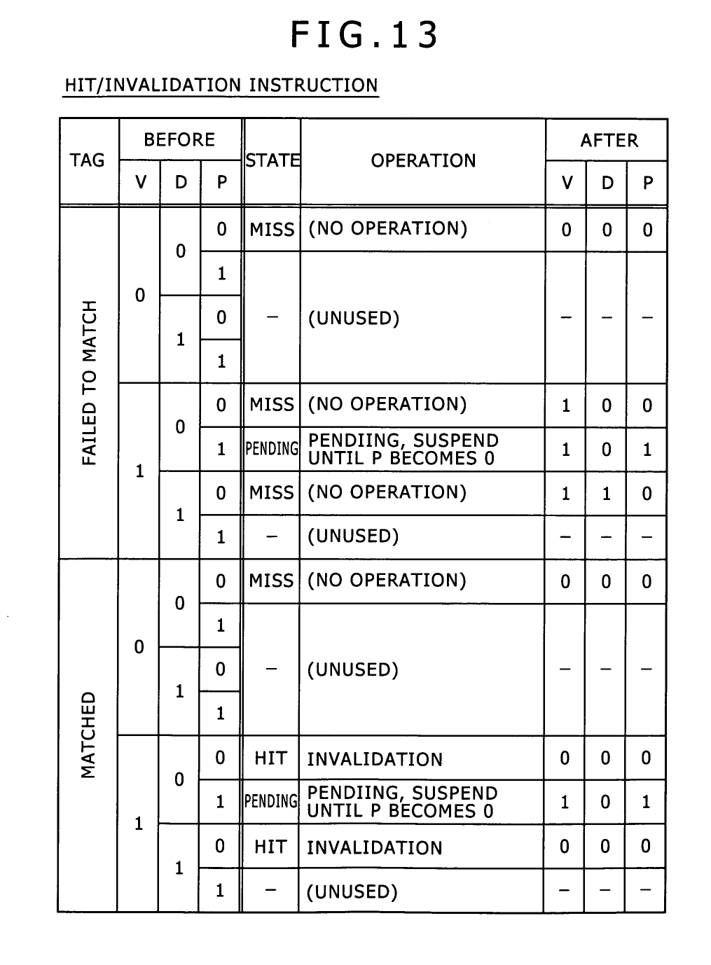

FIG. 13 is a diagram illustrating exemplary operations performed by the Level 2 cache 200 according to this embodiment of the present invention, in response to a hit/invalidation instruction. The hit/invalidation instruction is an instruction to, when a hit occurs in the Level 2 cache 200, invalidate the relevant cache line. Note, however, that when a miss hit occurs in the Level 2 cache 200, no operation is performed.

Suppose that either of the comparators 231 and 232 has detected a matching of the tag addresses with respect to a given entry. In this case, if V=1, then a hit determination is made basically, and the relevant cache line is invalidated. At this time, even if D=1, the data in the cache line is not written back to the main memory 300.

However, even when a matching of the tag addresses is detected and V=1, if P=1, the pending state results. That is, in this case, since the relevant cache line is waiting for data from the main memory 300, this cache line cannot be invalidated at the moment. Accordingly, the invalidation is suspended until P=0 comes to hold. During this time, accesses to the Level 2 cache 200 based on other instructions are accepted.

In the case where a matching of the tag addresses is not detected in either of the comparators 231 and 232, and in the case where a matching of the tag addresses is detected in either of the comparators 231 and 232 but V=0, a miss hit determination is made basically, and no operation is performed.

However, when a matching of the tag addresses is not detected and P=1, the pending state results. That is, in this case, since the relevant cache line is waiting for data from the main memory 300, this cache line cannot be used at the moment. Accordingly, completion of the hit/invalidation instruction is suspended until P=0 comes to hold. During this time, accesses to the Level 2 cache 200 based on other instructions are accepted.

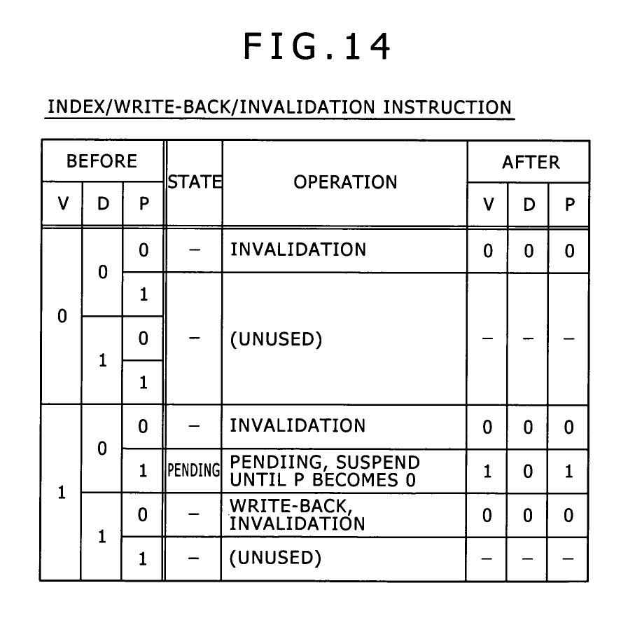

FIG. 14 is a diagram illustrating exemplary operations performed by the Level 2 cache 200 according to this embodiment of the present invention, in response to an index/write-back/invalidation instruction. The index/write-back/invalidation instruction is an instruction to, if D=1 in a specified cache line, write the data in this cache line back to the main memory 300 and invalidate the cache line. However, if D=0 in the specified cache line, only the invalidation is performed. As such, the operation performed in response to the index/write-back/invalidation instruction is independent of the result of the comparison of the tags.

If V=1 in the specified cache line, this cache line is invalidated. At this time, if D=1, then the data in this cache line is written back to the main memory 300 prior to the invalidation.

However, even when V=1, if P=1, the pending state results. That is, in this case, since the specified cache line is waiting for data from the main memory 300, this cache line cannot be invalidated at the moment. Accordingly, the invalidation is suspended until P=0 comes to hold. During this time, accesses to the Level 2 cache 200 based on other instructions are accepted.

Meanwhile, if V=0 in the specified cache line, this cache line is invalidated.

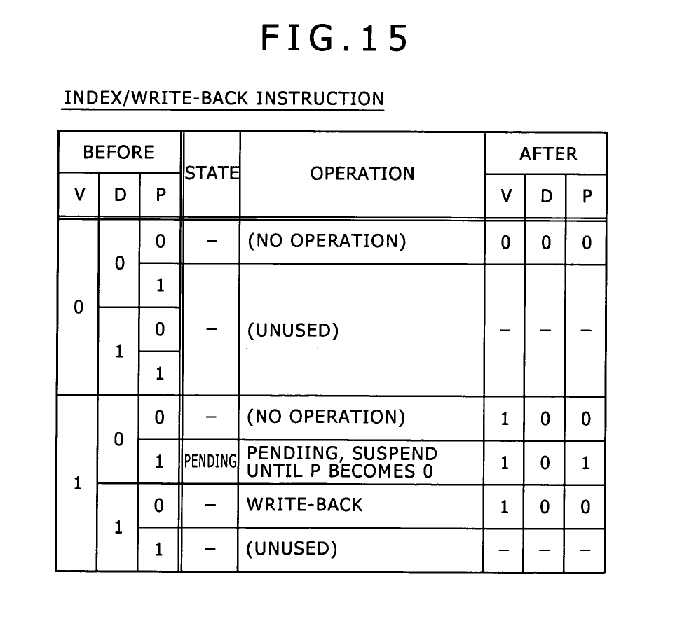

FIG. 15 is a diagram illustrating exemplary operations performed by the Level 2 cache 200 according to this embodiment of the present invention, in response to an index/write-back instruction. The index/write-back instruction is an instruction to, if D=1 in a specified cache line, write the data in this cache line back to the main memory 300. Note, however, that if D=0 in the specified cache line, no operation is performed. As such, the operation performed in response to the index/write-back instruction is independent of the result of the comparison of the tags.

If V=1 and D=1 in the specified cache line, the data in this cache line is written back to the main memory 300. Meanwhile, if D=0, no operation is performed.

However, even when V=1, if P=1, the pending state results. That is, in this case, since the specified cache line is waiting for data from the main memory 300, this cache line cannot be used at the moment. Accordingly, completion of the index/write-back instruction is suspended until P=0 comes to hold. During this time, accesses to the Level 2 cache 200 based on other instructions are accepted.

Meanwhile, if V=0 in the specified cache line, no operation is performed.

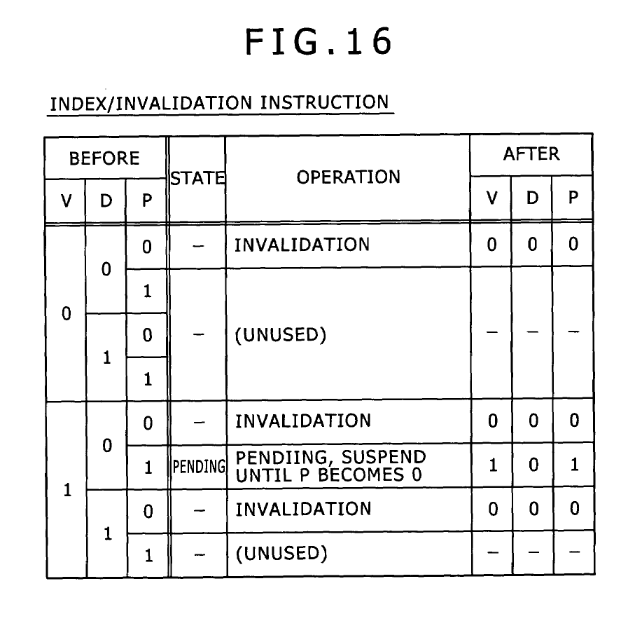

FIG. 16 is a diagram illustrating exemplary operations performed by the Level 2 cache 200 according to this embodiment of the present invention, in response to an index/invalidation instruction. The index/invalidation instruction is an instruction to invalidate a specified cache line. As such, the operation performed in response to the index/invalidation instruction is independent of the result of the comparison of the tags.

If V=1 in the specified cache line, this cache line is invalidated. At this time, even if D=1, the data in the cache line is not written back to the main memory 300.

However, even when V=1, if P=1, the pending state results. That is, in this case, since the specified cache line is waiting for data from the main memory 300, this cache line cannot be invalidated at the moment. Accordingly, the invalidation is suspended until P=0 comes to hold. During this time, accesses to the Level 2 cache 200 based on other instructions are accepted.

Meanwhile, if V=0 in the specified cache line, this cache line is invalidated.

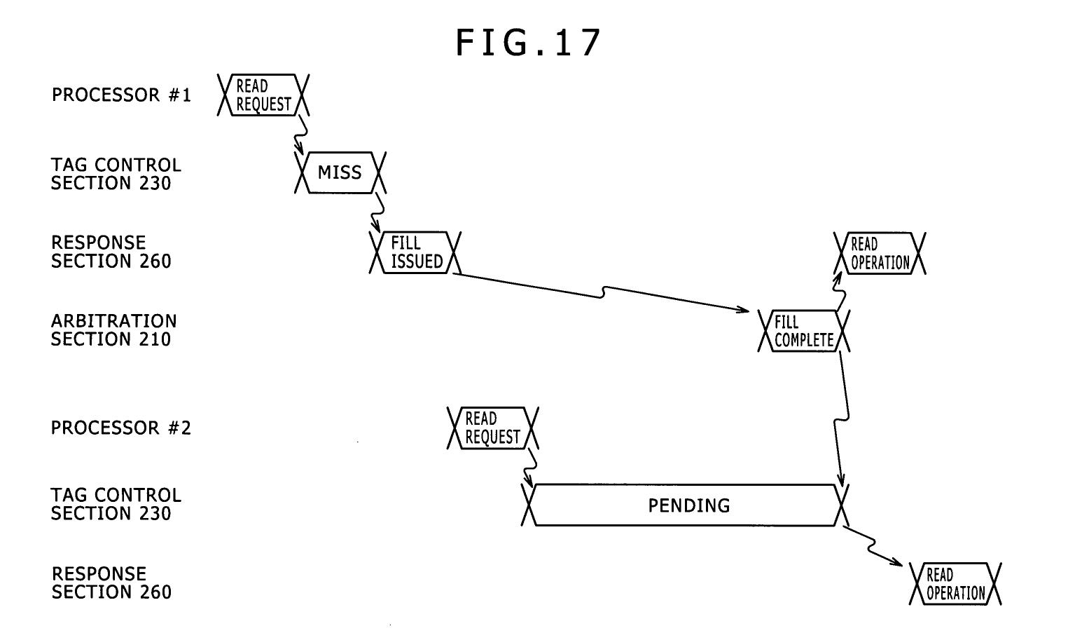

FIG. 17 is a timing diagram illustrating exemplary operations performed when the read instructions are issued, according to this embodiment of the present invention. This example assumes the case where due to a prior access, a subsequent access involves the pending state.

The read instruction is issued from processor #1 (100-1), and the tag control section 230 of the Level 2 cache 200 determines that a miss hit has occurred. Then, the response section 260 of the Level 2 cache 200 issues an instruction to fill a relevant cache line to the main memory 300.

Suppose that thereafter the read instruction is issued from processor #2 (100-2), and that the tag control section 230 of the Level 2 cache 200 detects the pending state. In other words, suppose that a read access is made to the same cache line for which processor #1 has issued the read instruction. In this case, the tags match each other and V=1 and D=0, but P=1. Therefore, the read instruction issued from processor #2 cannot be executed at the moment, but the execution thereof is suspended.

Relevant data is transferred in response to the fill instruction from processor #1, arbitration is achieved by the arbitration section 210, and the result is reflected in the tag storage section 220 and the data storage section 240. Then, the data requested by the read instruction from processor #1 is transferred to processor #1 via the response section 260. As a result, the pending field of the relevant entry is cleared, resulting in P=0.

As a result of this shift to P=0, data requested by the read instruction issued from processor #2 is transferred to processor #2 via the response section 260 as well.

In the above example, because it is assumed that the read access of the read instruction from processor #2 is aimed at the same cache line for which processor #1 has issued the read instruction, the read access from processor #2 is suspended. Note that an access to another cache line can be performed without suspension, as long as storage coherence is maintained.

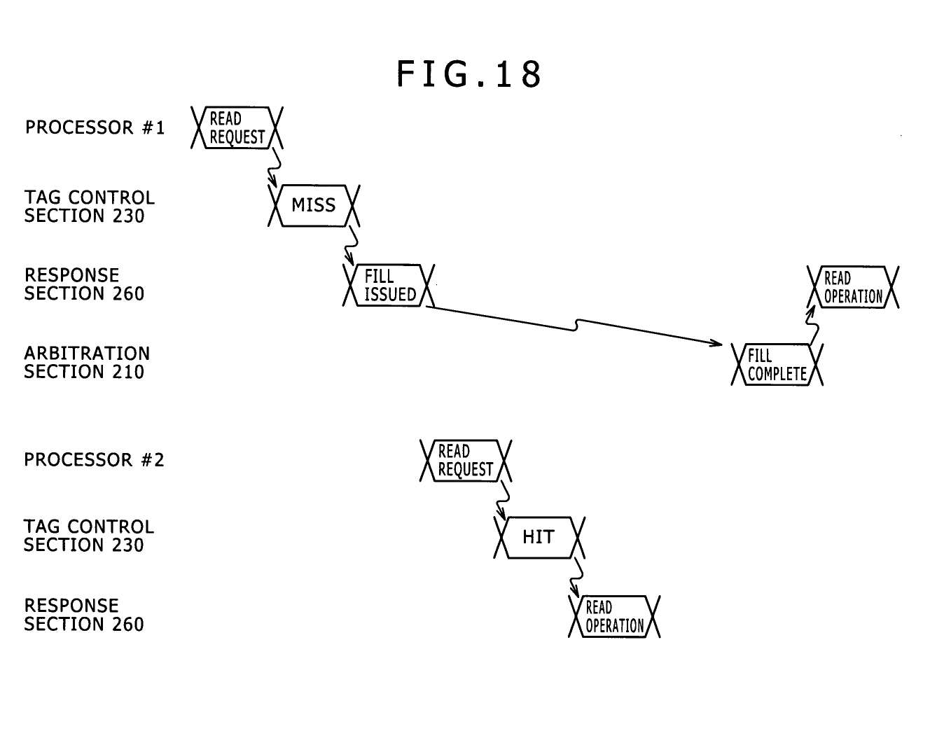

FIG. 18 is a timing diagram illustrating other exemplary operations performed when the read instructions are issued, according to this embodiment of the present invention. This example assumes the case where the subsequent access is performed without waiting for the prior access to be completed.

The read instruction is issued from processor #1 (100-1), and the tag control section 230 of the Level 2 cache 200 determines that a miss hit has occurred. Then, the response section 260 of the Level 2 cache 200 issues an instruction to fill a relevant cache line to the main memory 300.

Suppose that thereafter the read instruction is issued from processor #2 (100-2), and that the tag control section 230 of the Level 2 cache 200 determines that a hit has occurred. In other words, suppose that a read access is made to a different cache line from that for which processor #1 has issued the read instruction. In this case, the tags match each other and V=1, D=0, and P=0. Therefore, the read instruction issued from processor #2 can be executed without the need to wait for the read instruction from processor #1 to be completed. That is, the data requested by the read instruction from processor #2 is transferred to processor #2 via the response section 260 quickly (hit-under-miss).

Thereafter, relevant data is transferred in response to the fill instruction from processor #1, arbitration is achieved by the arbitration section 210, and the result is reflected in the tag storage section 220 and the data storage section 240. Then, the data requested by the read instruction from processor #1 is transferred to processor #1 via the response section 260. As a result, the pending field of the relevant entry is cleared, resulting in P=0.

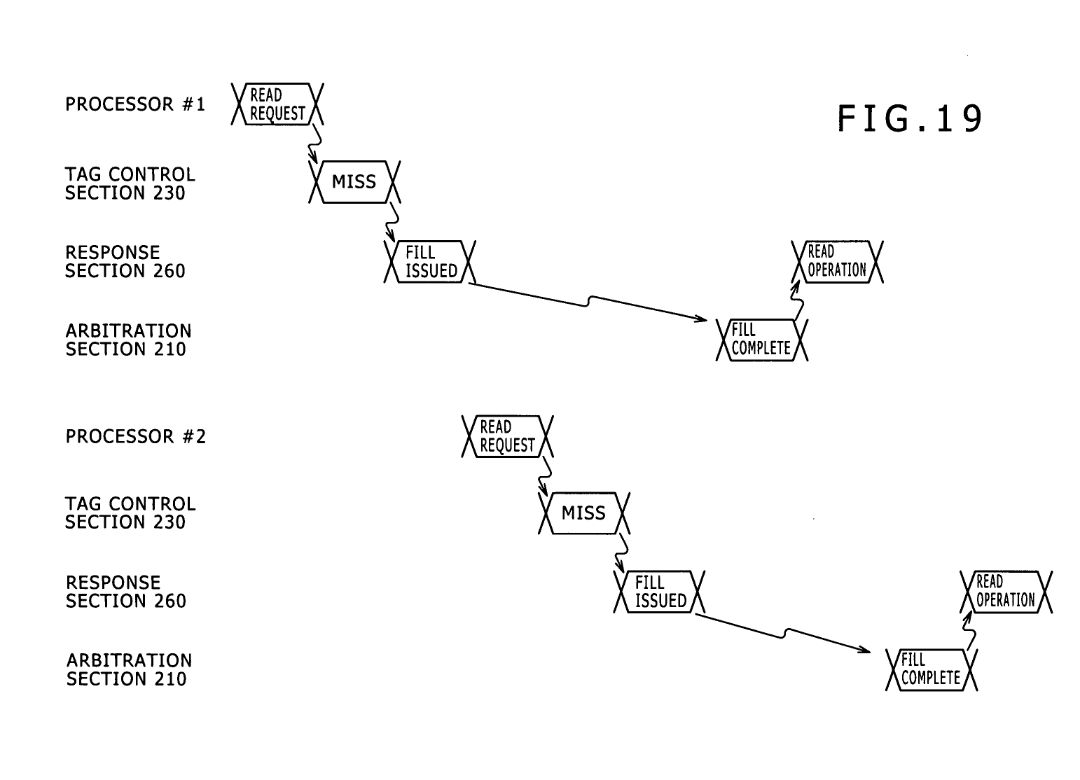

FIG. 19 is a timing diagram illustrating still other exemplary operations performed when the read instructions are issued, according to this embodiment of the present invention. This example assumes the case where, during a process of handling a miss for the prior access, a process of handling a miss for the subsequent access is performed.

The read instruction is issued from processor #1 (100-1), and the tag control section 230 of the Level 2 cache 200 determines that a miss hit has occurred. Then, the response section 260 of the Level 2 cache 200 issues an instruction to fill a relevant cache line to the main memory 300.

Suppose that thereafter the read instruction is issued from processor #2 (100-2) for a different cache line from that for which processor #1 has issued the read instruction, and that the tag control section 230 of the Level 2 cache 200 determines that a miss hit has occurred. In this case, without waiting for the read instruction from processor #1 to be completed, the response section 260 of the Level 2 cache 200 issues an instruction to fill a relevant cache line to the main memory 300 (miss-under-miss).

Thereafter, relevant data is transferred in response to the fill instruction from processor #1, arbitration is achieved by the arbitration section 210, and the result is reflected in the tag storage section 220 and the data storage section 240. Then, the data requested by the read instruction from processor #1 is transferred to processor #1 via the response section 260. As a result, the pending field of the entry relevant to the read instruction from processor #1 is cleared, resulting in P=0.

Similarly, relevant data is transferred in response to the fill instruction from processor #2, arbitration is achieved by the arbitration section 210, and the result is reflected in the tag storage section 220 and the data storage section 240. Then, the data requested by the read instruction from processor #2 is transferred to processor #2 via the response section 260. As a result, the pending field of the entry relevant to the read instruction from processor #2 is cleared, resulting in P=0.

As described above, according to this embodiment of the present invention, the provision of the pending field 224 in the tag storage section 220 makes it possible to suspend the access to any cache line that is waiting to be filled with data, while permitting access to other cache lines. In the case of set-associative caches, the number of cache lines is the product of the number of lines and the number of ways, and 128×2=256 in the example of FIG. 3. That is, in this example, a maximum of 256 accesses can be put in suspension. This takes advantage of a tag comparing mechanism of the cache memory, and accomplishes the access suspension with simple structure, without the need to add an address comparison circuit. This can handle not only the case where a hit occurs for a subsequent access during the process of handling a miss for a previous access (hit-under-miss), but also the case where a miss occurs for a subsequent access during the process of handling a miss for a previous access (miss-under-miss), as long as the cache lines concerned are different.

In the description of preferred embodiments of the present invention, the write-back Level 2 cache has been described by way of illustration. Note, however, that the present invention is not limited to the write-back Level 2 cache. For example, the present invention is also applicable to a write-through cache.

Also, in the description of the preferred embodiments, the Level 2 cache has been described by way of illustration. Note, however, that the present invention is not limited to the Level 2 cache. For example, the present invention is also applicable to cache memories on other levels (e.g., the Level 1 cache).

Note that each procedure described in the foregoing description of the preferred embodiment can be considered as a method including the series of steps in the procedure, a program for causing a computer to execute the series of steps, or a storage medium storing that program. Examples of this storage medium include a compact disc (CD), a MiniDisc (Registered Trademark of Sony Corporation), a digital versatile disk (DVD), a memory card, and a Blu-ray Disc (Registered Trademark of Sony Corporation).

The present application contains subject matter related to that disclosed in Japanese Priority Patent Application JP 2008-197243 filed in the Japan Patent Office on Jul. 31, 2008, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A cache memory, comprising:
a tag storage section including
a plurality of entries each including
a tag address, and
a pending indication portion,
at least one of the entries being to be referred to by a first address portion of an access address;
a data storage section configured to store data corresponding to each of the entries;
a tag control section configured to compare a second address portion, different from the first address portion, of the access address with the tag address included in each of the at least one of the entries referred to to detect an entry whose tag address matches the second address portion, and, when the pending indication portion included in the detected entry indicates pending, cause an access related to the access address to be suspended; and
a data control section configured to select data corresponding to the detected entry from among said data storage section, when the pending indication portion included in the detected entry does not indicate pending.

2. The cache memory according to claim 1, wherein, when the tag address in none of the at least one of the entries referred to matches the second address portion, said tag control section replaces that one of the at least one of the entries whose pending indication portion does not indicate pending, in preference to any remaining one of the at least one of the entries.

3. The cache memory according to claim 2, wherein, when the pending indication portion included in the entry to be replaced indicates pending, said tag control section suspends replacement of the entry.

4. A cache memory control apparatus, comprising:
a tag storage section including
a plurality of entries each including
a tag address, and
a pending indication portion,
at least one of the entries being to be referred to by a first address portion of an access address; and
a tag control section configured to compare a second address portion, different from the first address portion, of the access address with the tag address included in each of the at least one of the entries referred to to detect an entry whose tag address matches the second address portion, and, when the pending indication portion included in the detected entry indicates pending, cause an access related to the access address to be suspended.

5. A cache memory, comprising:
tag storage means including
a plurality of entries each including
a tag address, and
a pending indication portion,
at least one of the entries being to be referred to by a first address portion of an access address;
data storage means for storing data corresponding to each of the entries;
tag control means for comparing a second address portion, different from the first address portion, of the access address with the tag address included in each of the at least one of the entries referred to to detect an entry whose tag address matches the second address portion, and, when the pending indication portion included in the detected entry indicates pending, causing an access related to the access address to be suspended; and
data control means for selecting data corresponding to the detected entry from among said data storage means, when the pending indication portion included in the detected entry does not indicate pending.

6. A cache memory control apparatus, comprising:
tag storage means including
a plurality of entries each including
a tag address, and
a pending indication portion,
at least one of the entries being to be referred to by a first address portion of an access address; and
tag control means for comparing a second address portion, different from the first address portion, of the access address with the tag address included in each of the at least one of the entries referred to to detect an entry whose tag address matches the second address portion, and, when the pending indication portion included in the detected entry indicates pending, causing an access related to the access address to be suspended.
